(19) United States
(12) Patent Application Publication
(10) Pub. No.: US 2003/0180499 A1
(43) Pub. Date: Sep. 25, 2003

(54) Magnetic multiple-component mat

(76) Inventors: Seiin Kobayashi, Yonezawa (JP); Thomas D. Nord, Newnan, GA (US); Akihito Suzuki, Kawanishi-Machi (JP)

Correspondence Address: Milliken & Company, P. O. Box 1927, Spartanburg, SC, 29304, US

(21) Appl. No.: 10/104,553

(22) Filed: Mar. 22, 2002

(51) Int. Cl. B32B 3/06; B32B 3/14

(52) U.S. Cl. 428/95; 428/900; 428/77; 428/78; 15/215; 15/217; 428/101

(57) ABSTRACT

There is provided a separable mat comprising a mat component and a base component having a flat surface for supporting the mat component. The mat component has a backing substrate, in which mat piles are implanted, and may include a magnetic composition applied to the backing substrate, in which magnetic particles are incorporated. Alternately, the mat component may include a base pile fabric to which a magnetic sheet is secured. In another embodiment, more than one mat component is secured to a single base component. The base component of the mat includes a flat surface for supporting the mat component(s). In one embodiment, a magnetic material, such as a magnetic sheet, is positioned on this flat surface. In an alternate embodiment, magnetic particles may be incorporated into the base component. The mat component may be dyed or printed to meet user specifications, and the base component may also be colored if so desired.

### TECHNICAL FIELD

The present invention relates to a mat made of separable components. More specifically, the invention relates to a separable mat that is comprised of a floor piece and at least one mat piece that may be separated from each other and that may be detachably attached together by magnetic force. The magnetic attraction between the floor piece and the mat piece(s) permits the floor piece and the mat pieces to be intimately adhered together during use, offering stability during use, consistent mat performance, and a safe flooring surface.

### BACKGROUND

Dust-control mats, which are used in entrances to retail and industrial settings, offices, and residences, can be classified into two types, that is, separable mats and unitary mats. Many of these mats have generally been used on a rental basis; the mats are rented to customers for a predetermined period of time and are then recovered, washed, regenerated, and rented again to the customers.

In the case of unitary mats, the base (or floor piece) and the mat piece have been constructed as a unitary structure. In the rental service business, therefore, the whole mat (including the base and the mat body) must be recovered and transported to and from the customer location. Moreover, the unitary mat as a whole must be washed and regenerated.

In the case of the separable mats, the separable mat has a base (or floor piece) that serves as an underlayer and a mat body that can be mechanically separated from each other. In a rental service business, only the mat bodies are removed, recovered, and transported from the customer to the laundry and back again. Advantageously, only the mat bodies must be washed and regenerated, resulting in reduced energy costs.

The base of the separable mat, being made of a rubber or the like, can be used semipermanently once it is laid. Therefore, the mat piece can be produced to meet a variety of user specifications, making it possible to offer many kinds of mats at a reduced cost.

Compared with the unitary mats, furthermore, only the mat piece needs be recovered, transported and stored. This results in the separable mats being light in weight and not bulky, reducing the burden of washing, and allowing the mats to be washed and regenerated at a low cost.

The separable mat, however, requires some adhesion mechanism between the mat piece and the base made of a rubber or the like. If the adhesion mechanism does not favorably work, the adhesive force is often lost between the mat and the rubber base arousing such inconvenience that the position is deviated and the mat edges are turned up, deteriorating the appearance. Moreover, safety may be compromised for the persons who walk on it, and the function of wiping the shoes is lost.

An adhesion mechanism between the mat body and the base (or floor piece) is necessary in a separable mat. In the separable mat, the following methods can be contrived regarding detachably securing the mat component and the base together. These methods include: (1) adhesion using a face fastener; (2) adhesion based on a combination of rugged surfaces; (3) adhesion using a mechanical fastening device; (4) chemical adhesion; and (5) adhesion using a magnetic material.

One physical and partial adhesion mechanism based upon a hook-and-loop fastener has generally been used as disclosed in, for example, Japanese Patent Publication No. 7450/1984. Described in detail, a female loop portion of the fastener is installed on the back surface of the mat body, while a male hook portion of the face fastener is installed on the upper surface of the base. From the standpoint of manufacturing steps, the face fastener must be stitched after the fabric is prepared, which increases the manufacturing cost.

The face fastener, in many cases, is installed on portions of the mat surface, i.e., installed at the corners and at the centers of the sides in general. When the face fastener is installed in this manner, e.g., on the corners, wrinkles may develop when non-adhered portions of the sides are contacted by the foot traffic. This characteristic may cause problems regarding (a) safety when walked over and (b) the deterioration of the mat appearance. When the face fastener is used along the whole sides, the mat may become undulated after repetitive washing due to a difference in the shrinkage between the mat cloth and the fastener portion.

When the mat as a whole is viewed, the adhesion portion becomes thicker by the thicknesses of the components of the face fastener, deteriorating the appearance and causing a problem in that the door cannot be smoothly opened or closed. With the adhesion system using the face fastener, the adhesion strength of the face fastener inevitably decreases after the mat is washed and regenerated repetitively.

In the case of the adhesion using rugged surfaces and a mechanical fastening device, a shape must be formed on the back surface of the fabric that inevitably results in an increase in cost and weight. Moreover, adhesive force is difficult to obtain in the vertical direction; rugged portions themselves are worn out through the repetitive washing of the fabric; and the fabric on the surface is deteriorated (worn out) causing the life of the mat to be shortened.

In the case of the adhesion using an adhesive material, the adhesive force decreases upon the infiltration of rain, sand and the like, making it difficult to stably maintain the adhesive force under all weather conditions.

In contrast with the above-mentioned adhesion methods, the adhesion using magnetic materials maintains the adhesive force favorably and stably against changes in an external environment and varies little even after repeated washing.

Moreover, several mechanisms have been proposed already in regard to adhering the mat body and the base together by using the magnetic force of a magnetic material as disclosed in, for example, Japanese Laid-Open Patent Publication No. 28413/79, Japanese Laid-Open Utility Model Publication No. 16976/1984, Japanese Laid-Open Utility Model Publication No. 95079/1985 and Japanese Laid-Open Patent Publication No. 118774/1985.

When using magnetic materials to adhere the mat components, the base that serves as an underlayer and the mat body must be strongly and evenly adhered together such that they maintain a sufficiently large adhesive force during use. For this purpose, the adhesion surface must be smooth and the gap must be as small as possible between the adhesion surfaces. In the case of a mat on which pile yarns are implanted, however, it is difficult to completely avoid the ruggedness caused by the stitching of pile yarns on the backing layer on the back surface of the fabric. When an ordinary magnetic material is used, therefore, it is in many cases difficult to establish a sufficiently strongly and uniformly fixed state.

The above-mentioned problem can be solved to some extent by using a magnetic material having stronger magnetic force. In rental mats, however, it is difficult to employ a magnetic material having a particularly strong magnetic force from the standpoint of cost and weight. In addition, when the mat is adhered using a magnetic material having a particularly strong magnetic force, it becomes difficult to maintain homogeneity of adhesion. Moreover, once the mat is fixed in a wrinkled state, it becomes difficult to correct the wrinkles.

Because of such circumstances, magnetic force has not yet been practically utilized for fixing the mat to the base though many proposals have been made regarding the use of magnetic force.

### SUMMARY

The object of the present invention therefore is to provide a separable mat that is free from the above-mentioned problems inherent in the prior magnetically secured separable mats. At the time of rental service, this feature enables the mat component to be easily removed and to be easily washed. The mat component—which is removed, transported, and laundered—is light in weight compared with the unitary mat. The magnetic adhesion between the mat piece and the floor piece is strong and stable against a change in the environment (e.g., rain, sunlight, or adhesion of dust).

According to one embodiment as will be described herein, there is provided a separable mat comprising a mat component and a base component having a flat surface for supporting the mat component. The mat component has a backing substrate, in which mat piles are implanted, and may include a magnetic composition applied to the backing substrate, in which magnetic particles are incorporated. Alternately, the mat component may include a base pile fabric to which a magnetic sheet is secured. In another embodiment, more than one mat component is secured to a single base component. The base component of the mat includes a flat surface for supporting the mat component(s). In one embodiment, a magnetic material, such as a magnetic sheet, is positioned on this flat surface. In an alternate embodiment, magnetic particles may be incorporated into the base component.

The mat component may be dyed or printed to meet user specifications, and the base component may also be colored if so desired.

### BRIEF DESCRIPTION OF THE DRAWINGS

FIG. 1A is a perspective view illustrating a separable mat according to the present disclosure;

FIG. 1B is a perspective view illustrating an alternate embodiment of the separable mat of the present disclosure;

FIG. 2 is a cross-sectional view illustrating the structure of one embodiment of the mat of FIG. 1A, in which the mat component includes magnetic particles incorporated therein and the base component includes a magnetic sheet;

FIG. 3A is a cross-sectional view illustrating the structure of an alternate embodiment of the mat of FIG. 1A, in which the mat component includes a magnetic sheet and the base component includes magnetic particles incorporated therein;

FIG. 3B is a cross-sectional view illustrating a variation of the mat of FIG. 3A, in which an adhesive layer is included between the mat component and the base component;

FIG. 4 is a cross-sectional view illustrating the structure of another embodiment of the mat of FIG. 1A, in which the mat component includes a magnetic sheet and the base component includes a magnetic sheet;

FIG. 5 is a cross-sectional view illustrating the structure of yet another embodiment of the mat of FIG. 1A, in which the mat component includes magnetic particles incorporated therein and the base component includes magnetic particles incorporated therein.

### DETAILED DESCRIPTION

The separable mat of the present disclosure comprises a mat body in which mat piles and a magnetic surface are implanted, and a base floor piece having a flat magnetic surface for supporting the mat. Here, in one embodiment, an elastomer coating blended with a magnetic powder is applied to the back surface of the mat component. To secure the mat components, at least a flat surface of the floor piece for supporting the mat is formed of a magnet rubber sheet.

The base component is typically rectangular and its edges typically extend beyond the edges of the mat component. The base component may be substantially flat across its surface for use in areas where low clearance is needed. Alternately, the base component may have a raised lip portion around its perimeter to capture dirt or water from users' footwear. Yet another embodiment of the base component features a plurality of wells into which a corresponding number of mat components is secured.

The separable mat of the present disclosure uses magnetic force to adhere the mat component and the base component together. Therefore, the adhesive force is stably obtained from the initial stage of adhesion until the mat component is removed. The adhesion maintains good adhesive force even against a change in an external environment, changes little with the passage of time even after repeated washings, and maintains a stable adhesive force across the mat as a whole.

In one embodiment of the separable mat, the base component for supporting the mat includes a magnetic rubber sheet and the backing portion of the mat component is formed of an elastomer blended with a magnetic powder. This combination has been found advantageous under certain circumstances, because of the relative weights of the base component and the mat component.

In the separable mat, the mat component is formed in a shape that complements the base component (described above). The elastomer backing layer blended with a magnetic powder is formed on the flat surface on the back of the mat component, and the magnetized base component is installed at a position facing the elastomer backing layer. Accordingly, the magnetic material-containing mat component and the magnetic rubber sheet of the base component are set as opposing flat surfaces maintaining a suitable positional relationship, and are adhered together strongly, homogeneously, and intimately.

Since the adhesion due to magnetic force is homogeneous between the two flat surfaces, ruggedness such as wrinkles is prevented from developing on the pile surface of the mat.

Usually, the elastomer backing surface of the mat component cannot be formed in a completely smooth surface and contains undulatory ruggedness caused by stitching. In securing the mat component to the base component, it is important that the stitches on the backing surface of the mat component be flattened as much as possible in order to increase the contact area relative to the base component, increase the adhesive force between the two components, and obtain a strongly adhered state.

The invention will now be described with reference to the accompanying drawings.

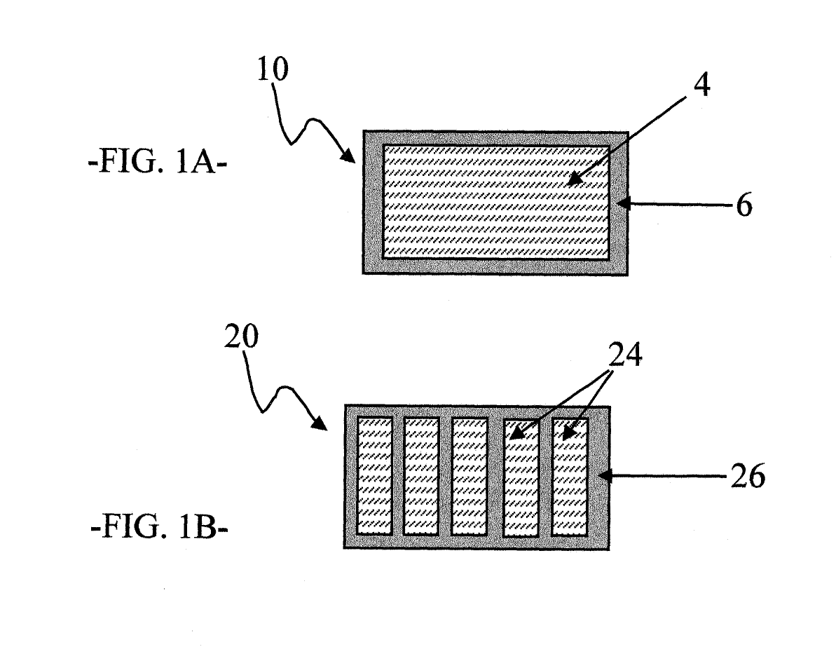

FIG. 1A is a perspective view illustrating the appearance of a separable mat according to one embodiment of the present disclosure. FIG. 1B is a perspective view of a separable mat having a plurality of mat components according to another embodiment of the present disclosure.

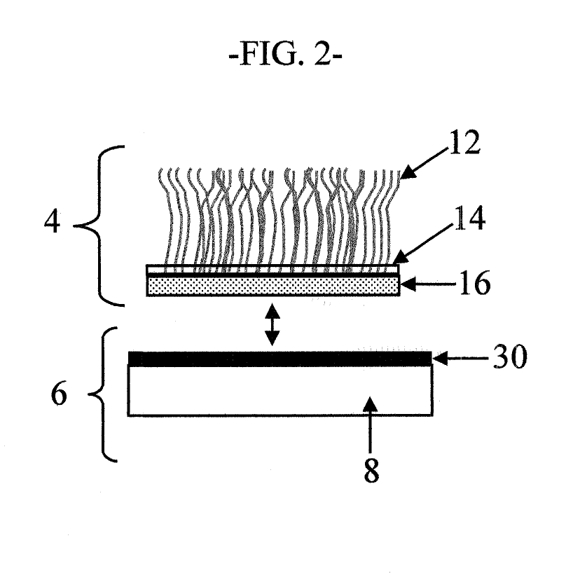

FIG. 2 is a cross-sectional view of one embodiment of the present disclosure, in which the mat component includes magnetic particles incorporated therein and the base component includes a magnetic sheet.

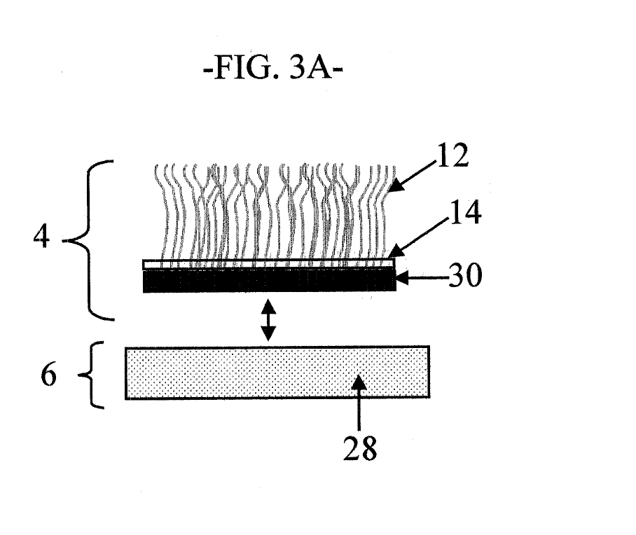

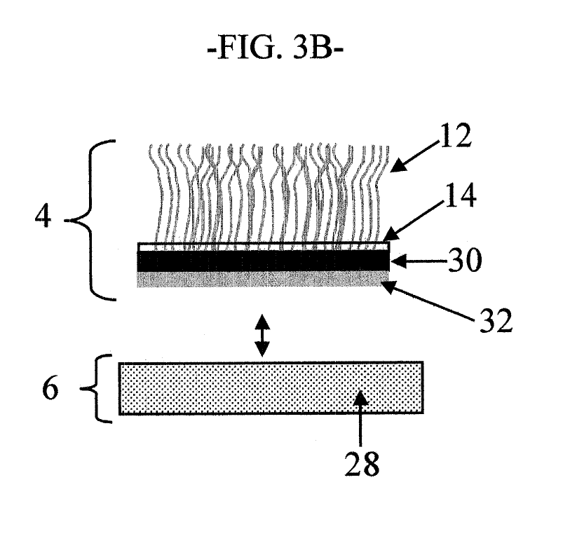

FIG. 3A is a cross-sectional view of another embodiment of the present disclosure, in which the mat component includes a magnetic sheet and the base component includes magnetic particles incorporated therein. FIG. 3B is a cross-sectional view of the mat of FIG. 3A, in which an adhesive layer has been included between the mat component and the base component.

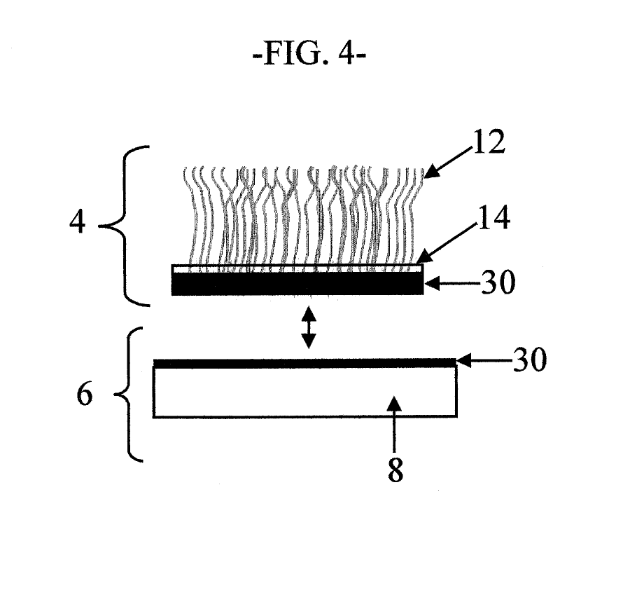

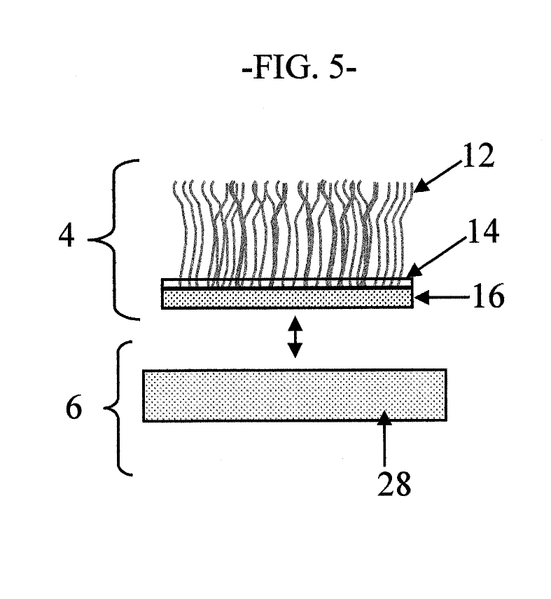

FIG. 4 is a cross-sectional view of yet another embodiment of the present disclosure, in which the mat component includes a magnetic sheet and the base component includes a magnetic sheet. FIG. 5 is a cross-sectional view of a further embodiment of the present disclosure, in which the mat component includes magnetic particles incorporated therein and the base component includes magnetic particles incorporated therein.

Each of the drawings will now be discussed in detail, preceding a discussion of the individual components of the present product.

FIG. 1A shows a separable floor mat 10. Mat component 4 is positioned over base component 6 and secured in place by magnetic force. Floor mat 10 is generally rectangular, but may have any other shape as desired by the user. As has been described, mat 10 may be substantially flat around the perimeter thereof or may include a raised lip (not shown) around the perimeter to capture dirt and water from users' shoes. Mat component 4 typically comprises a pile surface, as will be described herein. Both mat component 4 and base component 6 have a magnetic surface created by magnetic sheeting or magnetic particles as will be described herein.

FIG. 1B shows a separable floor mat 20, which is an alternate embodiment to floor mat 10. Floor mat 20 comprises a base component 26 and a plurality of mat components 24. Base component 26 may further include a corresponding plurality of wells or recessed areas (not shown) into which mat components 24 may be secured. Although mat components 24 are shown as being positioned across the width of mat 20, they may be positioned lengthwise as well. Further, mat components 24 may have various widths and/or shapes, as might be desired by users thereof. Like mat component 4, mat components 24 also comprise a pile surface. Mat components 24 and base component 26 also secured by magnetic force, each having a magnetic component that includes either magnetic sheeting or magnetic particles.

Though the mat component used in the present mat is constructed as described above with relation to FIGS. 1 and 1A, it should be noted that there is no particular limitation on the planar shape, the length of the mat pile, the shape of the surface portion, or the color. The mat can be realized in any planar shape and in any pile shape that are usually employed for mats.

FIG. 2 shows a cross-sectional view of one embodiment of mat component 4 and base component 6. Mat component 4 comprises pile yarns 12 that are secured to a backing substrate 14. A magnetic composition 16, which contains magnetic particles, is affixed to the back surface of backing substrate 14. Base component 6 includes magnetic film 30 that is secured to floor piece 8. Magnetic film 30, which may be part of an extruded magnetic sheet, is attached to floor piece by means of an adhesive or adhesive layer. For example, an thermoplastic elastomer (TPE) layer can be used to secure magnetic film 30 to floor piece 8 by heating the three layers to a temperature high enough to bond the layers. Floor piece 8 can be made from any material such as, but not limited to, dense rubber, foam rubber, urethane, polypropylene, nylon, polyethylene, polyester, acrylonitrile-butadienesytrene, polyvinyl chloride, other thermoplastic elastomers or thermoset plastics, or any combination thereof. Additionally, floor pieces 8 and 28 (see FIGS. 3A, 3B, and 5) may be black, white, or any other color that may be desired by the end user.

An alternative to using magnetic film 30 to secure components 4, 6 is to incorporate magnetic particles into another material to create magnetic composition 16. Examples of suitable materials for magnetic composition 16 include, but are not be limited to, rubber, urethane, polypropylene, polyethylene, nylon, polyester, acrylonitrile-butadiene-styrene, polyvinyl chloride, other thermoplastic elastomers or thermoset plastics, or any combination thereof, into which magnetic particles have been incorporated.

Pile yarns 12 to be provided on backing substrate 14 may consist of new or recycled materials. Pile yarns 12 may be multifilament or monofilament yarns made from, but not limited to, nylon, polyester, acrylic, cotton, wool, polypropylene, or any combination thereof. Pile yarns 12 can be placed in backing substrate 14 by any known method such as tufting, needle punching, sewing, embroidering, hooking or the like method. The kind of the pile may be a cut pile or a loop pile. The size of the monofilament fibers can range from about 100 dpf to about 5000 denier per filament (dpf) and preferably ranges from about 100 dpf to about 2000 dpf. The size of fine fibers used in the present mat can range from about 0.1 dpf to about 100 dpf, and preferably ranges from about 1 dpf to about 50 dpf. The fibers used to create pile yarns 12, whether new or recycled, can be undyed, space dyed, solution dyed, atmospherically dyed, or pressure dyed, for example.

Pile yarns 12 may be dyed to suit the decor of the surroundings in which mats 10 or 20 are placed. There is great flexibility in the dyeing or printing of pile yarns 12 of mat components 4, 24. Solid colors, lettering, patterns, logos, and any combination of these elements may be successfully employed.

Backing substrate 14, into which pile fibers 12 are inserted, may be a woven, knitted, or nonwoven fabric, and the fiber that constitutes backing substrate 14 may be new or recycled. The fibers used in backing substrate 14 may be, by way of example and not limited to, polyester, polypropylene, nylon, acrylic, cotton, or combinations thereof. Pile yarns 12 and backing substrate 14 may comprise any material that can be constructed as, by way of example, a tufted cut pile, a tufted loop pile, a needle-punched fabric, a woven fabric, or a knit fabric.

FIG. 3A shows a cross-sectional view of another embodiment of mat component 4 and base component 6. Mat component 4 comprises pile yarns 12, a backing substrate 14, and a magnetic film 30. Base component 6 includes a floor piece 28 into which magnetic particles have been incorporated. The magnetic attraction between magnetic film 30 and the magnetic particles creates a stable mat surface. To give floor piece 28 magnetic properties, magnetic filler material may be mixed into floor piece 8 before it is formed into its final shape. For example, floor piece 28 may be made magnetic by mixing small particles of material attracted by magnetic force (such as iron particles) in the floor piece material before it is given its final shape. In the case of iron particles, the magnetic property of the mat components 4 will attract the iron particles in floor piece 28, resulting in magnetic adhesion between the components.

FIG. 3B shows a cross-sectional view of a slightly different embodiment than is shown in FIG. 3A. In this variation, an adhesive layer 32 is sandwiched between magnetic film 30 and floor piece 28 to further secure the structure. Adhesive layer 32 may be used to either permanently or temporarily affix mat component 4 to base component 6.

FIG. 4 shows a cross-sectional view of yet another embodiment of mat component 4 and base component 6. Mat component 4 comprises pile yarns 12, a backing substrate 14, and magnetic film 30. Base component 6 also includes magnetic film 30 that is secured to floor piece 8. The composition of magnetic film 30 and floor piece 8 is the same as has been described above.

FIG. 5 shows a cross-sectional view of a further embodiment of mat component 4 and base component 6. Mat component 4 comprises pile yarns 12, a backing substrate 14, and magnetic composition 16. Base component 6 includes a floor piece 28 into which magnetic particles have been incorporated.

The present product offers many benefits over others' attempts. First, because of the magnetic force between the mat component(s) and the base component, the mat lies flat. This makes for a more attractive mat and decreases the likelihood of the mat becoming a trip hazard. Furthermore, the mat is more capable of fulfilling its intended purpose, that being the removal of dirt from users' shoes.

Second, the present product is less expensive to transport to and from an industrial laundry, since only the mat components must be transported. In addition, because only the mat components must be laundered, the expense of laundering is also decreased.

Finally, the mat components of the present product are highly customizable, capable of being printed or dyed in any pattern or color as may be desired by the user. Solid colors, patterns, logos, lettering, and the like can easily be incorporated in the pile surface of the mat components. Additionally, the base component can also be colored to coordinate with the mat components and the users' overall decor.

We claim:

1. A separable floor mat comprising a base component and at least one mat component, wherein said mat component includes a magnetic constituent and said base component includes a magnetic constituent, said mat component and said base component being detachably attached to one another by magnetic force, wherein said mat component further comprises a backing substrate and mat piles implanted in said backing substrate and wherein said magnetic constituent is selected from the group consisting of a magnetic film and magnetic particles.

2. The floor mat of claim 1, wherein said mat component includes a magnetic composition adhered to the backing substrate, said magnetic composition including magnetic particles incorporated therein and wherein said base component includes magnetic particles incorporated therein.

3. The floor mat of claim 1, wherein said mat component includes a magnetic film adhered to the backing substrate and wherein said base component includes magnetic particles incorporated therein.

4. The floor mat of claim 3, wherein an adhesive layer is positioned between the magnetic film that is adhered to the backing substrate and said base component that includes magnetic particles incorporated therein.

5. The floor mat of claim 1, wherein said mat component includes a magnetic film adhered to the backing substrate and wherein said base component includes a magnetic film adhered thereto.

6. The floor mat of claim 1, wherein said mat component includes a magnetic composition adhered to the backing substrate, said magnetic composition including magnetic particles incorporated therein and wherein said base component includes magnetic particles incorporated therein.

7. The floor mat of claim 1, wherein said floor mat comprises a plurality of mat components that are magnetically secured in wells formed in said base component.
